(19) United States
(12) Patent Application Publication
(10) Pub. No.: US 2022/0413111 A1
(43) Pub. Date: Dec. 29, 2022

(54) Lidarvorrichtung

(71) Applicant: Robert Bosch GmbH, Stuttgart (DE)

(72) Inventors: Akos Hegyi, Mezöhegyes (HU); Bence Balint, Delegyhaza (HU); Janos Simonovics, Pecs (HU); Mate Hornyak, Pakozd (HU); Mihaly Nagy, Torokbalint (HU); Peter Deak, Budapest (HU); Peter Kosaras, Budapest (HU); Zoltan Varga, Kecskemet (HU)

(21) Appl. No.: 17/850,424

(22) Filed: Jun. 27, 2022

(30) Foreign Application Priority Data
Jun. 29, 2021 (DE) 10 2021 206 718.2

(51) Int. Cl. G01S 7/497; G01S 17/931; G01S 7/481

(52) U.S. Cl. CPC G01S 7/497; G01S 17/931; G01S 7/4813; G01S 2007/4977

(57) ABSTRACT

The invention relates to a lidar device (10a-10l) having a cleaning unit (12a-12l) which has at least one wiper unit (14a-14l) having at least one wiper blade (16a-16l) for mechanically cleaning a cover element (18a-18l) of a lidar unit (20a-20l), and having at least one pressing element (22a-22l) which in a mounted state provides a pressing force for the wiper blade (16a-16l).

### BACKGROUND

A lidar device has already been proposed which is mounted on a road vehicle and which is provided for detecting the surrounding area of the vehicle. The lidar device has a lidar unit, at least one cover element which covers the lidar unit, and a cleaning unit which is configured to clean the window element.

### SUMMARY

The invention relates to a lidar device having a cleaning unit which has at least one wiper unit having at least one wiper blade for mechanically cleaning a cover element of a lidar unit, and having at least one pressing element which, in a mounted state, provides a pressing force for the wiper blade.

The lidar device is in particular at least a part, preferably at least a sub-assembly, at least of a lidar system, in particular of a lidar sensor assembly. The lidar device can in particular also comprise the entire lidar system, in particular the entire lidar sensor assembly. The lidar device has in particular at least one lidar unit which comprises in particular at least one lidar sensor element. The lidar sensor element is provided, for example, on a vehicle for detecting the environment, in particular for autonomous driving, on construction sites for surveying buildings, for the scanning of 3D contours and/or in the laboratory for research purposes. In particular, the lidar device is provided for detecting and/or surveying objects, in particular by means of the at least one lidar sensor element. Preferably, the lidar device is provided for use on a vehicle; in particular, the lidar device can be part of the vehicle. It would additionally be conceivable that the lidar device can be retrofitted to the vehicle. For example, the lidar device could be retrofitted to the vehicle in addition to an already existing lidar system of the vehicle. Preferably, the lidar device, in particular as part of the lidar system, is provided for detecting objects, in particular in an environment of the vehicle. Preferably, the lidar device is coupled with the vehicle, preferably in a roof region, a front region and/or a rear region of the vehicle, for detecting objects. In particular, the vehicle could have a plurality of lidar devices.

The vehicle can be in the form of a road vehicle, for example a passenger car or a truck or the like, in the form of a rail vehicle such as a train, a locomotive, a tram or the like, and/or in the form of a water craft, for example a ship, a boat or the like. In addition, it would be conceivable that the vehicle is in the form of a cleaning vehicle, in particular a robot cleaner, for example a robot mop and/or a robot vacuum cleaner. Preferably, the lidar device is connected to the vehicle. Preferably, the lidar device is arranged at least in part on an outer side of the vehicle.

In particular, the lidar unit has a cover element. The cover element covers the lidar unit in particular to the outside. In particular, the cover element is at least substantially transparent. It would be conceivable that the cover element is formed at least for the most part and in particular entirely of glass. Preferably, the cover element is formed at least for the most part and in particular entirely of a plastics material. In particular, the cover element is provided for protecting the lidar unit in particular from environmental influences. In particular, the cover element protects the lidar unit at least from environmental influences, for example precipitation, in particular rain and/or snow and/or ice. In particular, the cleaning unit is provided for cleaning the cover element mechanically, in particular by means of a mechanical component. In particular, the mechanical component is other than air and/or water. The cleaning unit could be provided for additionally cleaning the cover element by means of a cleaning fluid. It would be conceivable that the cleaning unit has at least one fluid nozzle and preferably a plurality of fluid nozzles which are provided for spraying the cleaning fluid onto the cover element in the operating state. For example, the fluid nozzles could be connected to a fluid supply unit already present in the vehicle. It would additionally be conceivable that the cleaning unit has a separate fluid supply unit which comprises, for example, at least one fluid supply line, at least one fluid tank and at least one fluid pump. For example, the fluid nozzles could spray the cleaning fluid onto the cover element only when required. For this purpose, a coupling to at least one rain sensor provided on the vehicle could be provided, for example. In particular, at least one element of the lidar device could be so configured in terms of its shaping that soiling of the cover element is reduced in the operating state, for example if at least one element is configured in terms of its shaping as a spoiler element. In particular, the lidar device could have at least one cover plate which in particular is not transparent. In particular, at least some elements of the lidar device could be arranged at least in part and preferably entirely behind the cover plate.

The expression “at least for the most part” is thereby to be understood as meaning at least 55%, advantageously at least 65%, preferably at least 75%, particularly preferably at least 85% and particularly advantageously at least 95%. “At least substantially” is to be understood in this context as meaning that a deviation from a given value is in particular less than 25%, preferably less than 10% and particularly preferably less than 5% of the given value.

An “operating state” is to be understood as being a state in which the lidar device is ready for operation, in particular for a detection operation. In particular, the cleaning unit cleans the window element mechanically in the operating state. It would additionally be conceivable that the cleaning unit cleans the cover element in the operating state only as required, in particular when there is dirt on the window element.

For cleaning the window element, the cleaning unit has at least one wiper unit. In addition, the cleaning unit has a transport unit for driving the wiper unit, which transport unit is provided in particular for moving the wiper unit over the cover element, in particular linearly over the cover element, in order to clean the cover element. In particular in the operating state, the transport unit moves the wiper unit linearly, and in particular bidirectionally, over the cover element in order to clean the cover element. It would be conceivable that the transport unit guides the wiper unit in a circular movement over the cover element in order to clean the cover element. In particular, the transport unit moves the wiper unit along the entire surface of the cover element in the operating state, in particular in order to mechanically clean the entire surface of the cover element.

In the mounted state, the wiper unit could be removably connected to the transport unit. In particular, the wiper unit in the mounted state could be connected to the transport unit in such a manner that it is removable without a tool. In particular, the wiper unit and/or the transport unit are designed so that a user, in particular an end user of the vehicle, can remove the wiper unit from the transport unit without a tool.

In particular, the wiper unit has at least one wiper blade which is provided for wiping the cover element, in particular in the operating state. In particular, the wiper blade of the wiper unit is replaceable. A “wiper blade” is to be understood in this context as being a blade which is provided for wiping the cover element. Preferably, the wiper blade is made of a rubber material.

The pressing element is provided for providing a pressing force, in particular directed towards the cover element, for the wiper blade in the mounted state. In the operating state, the pressing element presses the wiper blade against the cover element. “Provided” is to be understood as meaning specially adapted, specially designed and/or specially equipped. That an object is provided for a particular function is to be understood as meaning that the object fulfils and/or performs that particular function in at least one use and/or operating state.

Safety in particular can be improved by the configuration according to the invention of the lidar device. In particular, improved properties in respect of cleaning of the cover element can be achieved. In particular, a cleaning efficiency and/or a cleaning action in respect of the cover element can be improved. Furthermore, improved properties in respect of the reliability of a lidar system can be provided. It can in particular be ensured that a wiper blade is always in contact with the cover element. The cover element can in particular reliably be kept free of dirt by the configuration according to the invention.

It is further proposed that the wiper unit has the pressing element. It would be conceivable that the pressing element is formed integrally with at least one element, in particular a component, of the wiper unit. “Integrally” is to be understood as meaning connected at least by substance-to-substance bonding, for example by a welding process, an adhesive bonding process, a process of molding on and/or another process that appears expedient to the person skilled in the art, and/or advantageously formed in one piece, for example by production from a casting and/or by production in a single- or multi-component injection molding process and advantageously from a single blank. Improved properties in respect of a construction can thereby in particular be achieved. In particular, mounting can thereby be facilitated. Furthermore, in particular in the case of replacement of the wiper unit, the pressing force can always be ensured. The reliability in particular can thereby be increased.

It is further proposed that the pressing element is in the form of an elastic element. An “elastic element” is to be understood as being an element which can repeatedly be deformed without the element thereby being mechanically damaged or destroyed, and which in particular automatically strives to return to a basic shape after deformation. Reliability and/or durability can thereby in particular be improved. Furthermore, the pressing force can be provided cost-efficiently by such a configuration.

For example, the pressing element could be formed at least in part and in particular entirely of a metallic material, for example steel, spring steel or the like. If the pressing element is formed at least in part of a flexurally elastic plastics material, advantageous properties can be achieved in particular in respect of reliability and/or cost efficiency. In particular, the pressing element is formed at least for the most part of a flexurally elastic plastics material. The expression “at least for the most part” is thereby to be understood as meaning at least 55%, advantageously at least 65%, preferably at least 75%, particularly preferably at least 85% and particularly advantageously at least 95%, in particular based on a total mass and/or a total volume. Preferably, the pressing element is formed entirely of a flexurally elastic plastics material.

It is further proposed that the pressing element has a substantially higher stiffness than the wiper blade. In particular, the pressing element has a stiffness which is, for example, at least 15%, advantageously at least 25%, particularly advantageously at least 40%, preferably at least 60% and particularly preferably at least 80% higher than the stiffness of the wiper blade, in particular based on the extensional stiffness and/or the shear stiffness and/or the flexural stiffness and/or the torsional stiffness of the wiper blade. Particularly advantageous properties in respect of a construction can thereby in particular be achieved. In particular, the reliability of the wiper blade can be ensured. Furthermore, a sufficient pressing force can thereby in particular be provided.

It is further proposed that the pressing element is provided for providing a degressive pressing force curve with respect to a distance of the wiper unit from the cover element, wherein the distance between the wiper unit and the cover element is so chosen that the pressing force, in particular a preload force, lies in an approximately linear part-region of the degressive pressing force curve. In particular, a pressing force curve of the pressing element runs such that the pressing element becomes degressively harder as the preload increases, in particular as the distance of the wiper unit from the cover element decreases. In particular, a preload of the pressing element is so chosen, constructionally, and in particular over the distance between the wiper unit and the cover element, that the pressing force in the mounted state lies in the approximately linear part-region of the degressive pressing force curve. In particular, the pressing force can thereby advantageously be kept at least substantially constant. Particularly advantageously, tolerances, in particular manufacturing tolerances, between the cover element and the wiper unit can thereby be compensated for. Furthermore, the reliability in particular can thereby be increased.

It is additionally proposed that the pressing element is integrally connected to the wiper blade. Preferably, the pressing element and the wiper blade are formed in one piece. In particular, the pressing element and the wiper blade could be configured so that they can be produced in a joint manufacturing step. In particular, the pressing element and the wiper blade are in the form of a joint assembly, in particular in the form of an assembly which can jointly be replaced. Particularly simple mounting can thereby be ensured in particular. In particular, handling can thereby be facilitated. Furthermore, in particular joint production of the wiper blade and/or of the pressing element can thereby be carried out.

It is further proposed that the wiper blade, in particular in the mounted state, is connected to the pressing element in a middle region of the pressing element. In particular, the wiper blade, in the mounted state, is connected to the pressing element, in particular when seen in a direction perpendicular to a main plane of extent of the cover element, in a middle region of the pressing element. A “main plane of extent” of a structural unit is to be understood as being a plane which is parallel to a largest side face of a smallest notional cuboid which just completely encloses the structural unit, and in particular runs through the mid-point of the cuboid. Preferably, the pressing element, in the mounted state, is connected to the wiper blade at least along a large part of a main extent of the wiper blade, particularly preferably along an entire main extent of the wiper blade. A “main extent” of an object is thereby to be understood as being an extent which runs parallel to a longest edge of a smallest geometrical cuboid which just completely encloses the object. A construction with improved properties in respect of wiping efficiency and/or in respect of production can thereby in particular be achieved. Furthermore, tipping of the wiper blade, in particular during a wiping operation, can thereby be ensured.

It is further proposed that the pressing element delimits at least in part at least one cavity. In particular when the pressing element is viewed in cross-section, the pressing element encloses the cavity at least in part and in particular completely, in particular based on a circumferential direction. In particular, at least one end region and advantageously at least both end regions of the cavity, in particular based on a main extent of the pressing element, could be open. In particular, the cavity forms a channel through the pressing element. In particular in the mounted state, in which the pressing element provides the pressing force for the wiper blade, a form, in particular a cross-section, of the cavity could differ from a form, in particular a cross-section, of the cavity in an unloaded state. It would be conceivable that the cavity, in the mounted state, is filled at least partially and in particular completely with a medium, for example with air and/or with a liquid, for example washing water. In particular, the medium is other than a material of which the pressing element is formed. In this context, “washing water” is to be understood as being a liquid that is suitable for washing and/or cleaning the cover element, such as in particular water, an alcohol or preferably a mixture that comprises a water component, an antifreeze component, an alcohol component and/or a fragrance component. In particular, the pressing element could delimit at least in part at least one further cavity. By means of such a configuration, advantageous properties in respect of the provision of the pressing force can in particular be achieved. Furthermore, a weight saving and/or a material saving can thereby advantageously be achieved.

It is additionally proposed that the wiper unit has a housing unit which supports the pressing element at least in one direction. In particular in the mounted state, the housing unit supports the pressing element at least in a direction away from the cover element. It would be conceivable that the housing unit supports the pressing element in the mounted state in at least one further direction, for example in a direction facing the cover element and/or in a direction perpendicular thereto. In particular, the housing unit encloses the pressing element in the mounted state. Preferably, the housing unit engages around the pressing element at least in part in the mounted state. For example, the housing unit could have at least one housing element having a holding groove, wherein the wiper blade and/or the pressing element can be pushed, in particular removably, into the holding groove. It would be conceivable that the wiper unit comprises at least one end cap which fixes the wiper blade and/or the pressing element in the mounted state with respect to the housing unit, in particular with respect to the housing element having the holding groove. In particular, the end cap fixes the wiper blade and/or the pressing element in the housing unit, in particular in the holding groove of the housing element. The provision of the pressing force in particular can be ensured by such a configuration. Furthermore, the construction can thereby be optimized in particular in respect of a variety of parts.

It is further proposed that the pressing element, in the mounted state, is connected to the housing unit in particular by positive engagement. “By positive engagement” is to be understood as meaning that contiguous faces of components that are connected together by positive engagement exert on one another a holding force that acts in the normal direction of the faces. In particular, the components are in geometrical engagement with one another. Particularly advantageous fixing of the pressing element to the housing unit can thereby in particular be achieved.

It is further proposed that the lidar device has a slide unit which is provided for reducing friction between the housing unit and the pressing element. In particular in the operating state, specifically during wiping operation of the wiper unit, the pressing element deforms and thereby moves relative to the housing unit. The slide unit is provided for reducing friction during the movement of the pressing element relative to the housing unit, in particular relative to the housing element. In particular, the slide unit is formed integrally at least in part with the housing unit and/or with the pressing element. The reliability in particular can be increased by means of such a configuration. Furthermore, in particular wear can thereby be reduced and thus in particular the service life of the cleaning unit can be increased.

It is additionally proposed that the slide unit comprises at least one recess arranged at the pressing element for reducing a contact surface between the pressing element and the housing unit. In particular, the slide unit could comprise at least one recess and in particular a plurality of recesses which are arranged, when viewed in cross-section, laterally at the pressing element. Advantageously, the slide unit could comprise a plurality of recesses which are arranged, when viewed in cross-section, on both sides of the pressing element. In particular, the slide unit reduces a contact surface between the pressing element and the housing unit, for example, at least by 20%, advantageously at least by 25%, particularly advantageously at least by 35%, preferably at least by 40%, particularly preferably at least by 50%. Friction between the pressing element and the housing unit in particular can be reduced by such a configuration. Furthermore, in particular wear can thereby be reduced and thus in particular the service life of the cleaning unit can be increased.

It is further proposed that the slide unit comprises, in at least a part-region of the pressing element and of the housing unit, at least one material pairing which has low friction. For example, the pressing element and/or the housing unit could have in at least the part-region at least one, in particular slidable, plastics material, for example polytetrafluoroethylene (PTFE). Alternatively or additionally, the pressing element and/or the housing unit could have in at least the part-region bronze and/or white metal and/or a bearing metal alloyed with lead, and/or an aluminum alloy and/or ceramics and/or a brass alloy. Friction between the pressing element and the housing unit in particular can be reduced by such a configuration. Furthermore, in particular wear can thereby be reduced and thus in particular the service life of the cleaning unit can be increased.

It is further proposed that the lidar device has the cover element and at least one relieving element, which adjoins the cover element and in particular is arranged spaced apart from the cover element, for relieving the wiper unit, in particular in a parking position of the wiper unit. In the operating state, in particular during a wiping operation, the wiper blade travels over the cover element and the relieving element. The relieving element provides a parking position for the wiper unit. In particular, parking of the wiper unit takes place in the region of the relieving element. In the operating state, in particular during a wiping operation, the wiper blade travels in particular bidirectionally over the cover element and a relieving element arranged on each side of the cover element. In particular, a change of direction of the wiper blade of the wiper unit takes place in the operating state, in particular during a wiping operation, in the region of the relieving element. The relieving element relieves the wiper lip, in particular the pressing element, as the wiper lip passes over the relieving element. In particular, the pressing element does not provide a pressing force for the wiper lip as the wiper lip passes over the relieving element, in particular owing to an increased distance between the wiper unit and the relieving element. In particular, the lidar device has at least two relieving elements, wherein a relieving element is arranged on each side of the cover element. In particular, the relieving element provides a tipping aid for the wiper lip. In particular, the wiper lip is dragged in the wiping direction during bidirectional wiping. In particular during bidirectional wiping by means of the wiper unit, a change of direction of the wiper unit and thus tipping of the wiper lip takes place in the region of the relieving element. In particular wear of the wiper unit, in particular of the wiper lip and/or of the pressing element, can be reduced by such a configuration. In addition, in particular a wiping efficiency, in particular an efficiency of cleaning by the wiper unit, can be increased.

It is additionally proposed that the relieving element is additionally provided for dissipating liquid. It would be conceivable that the relieving element provides and in particular defines at least in part a channel. It would be conceivable that the relieving element defines the channel together with at least one further element. The relieving element could define the channel completely. Preferably, the relieving element delimits the channel on three sides. In particular, the channel has a geometry with a width to depth ratio of not more than 1, wherein the width corresponds to a width of the channel in the wiping direction and the depth corresponds to a depth of the channel perpendicular to the wiping direction. For example, the relieving element could have at least one opening and in particular a plurality of openings, in particular drilled holes. The liquid which in particular the wiper unit conveys into the channel, for example rainwater and/or washing water and/or dirt, can flow away via the at least one opening. For example, the lidar device could have a suction means which in the operating state draws the liquid away by suction via the at least one opening. Preferably, an incident flow, in particular a headwind, dissipates the fluid via the at least one opening in the operating state. For example, the relieving element could have at least one guide element and in particular a plurality of guide elements which are provided for dissipating the liquid in the operating state, in particular via the openings. It would likewise be conceivable that the relieving element is free of openings and the at least one guide element is provided for conducting the liquid outwards away from the cover element. In particular, the at least one guide element is in the form of a rib and is preferably arranged to slope downwards at an angle in the wiping direction and/or starting from the wiping direction. It would be conceivable that the relieving element is arranged around the cover element. In this context, it would be conceivable that the at least one guide element, in particular the rib, is arranged around the cover element. Cleaning of the cover element in particular can be improved by such a configuration. In particular, safety can thereby be improved. Furthermore, “water pull back” can be reduced or prevented by such a configuration.

For example, the relieving element could be formed spaced apart from the cover element. It would additionally be conceivable that the relieving element is formed separately from the cover element. In particular, the relieving element and the cover element are manufactured from a single common piece. When the relieving element is formed integrally with the cover element, production of the cover element in particular can be facilitated. Furthermore, improved properties in respect of stability can in particular be achieved. In addition, mounting can in particular be facilitated.

It is further proposed that the relieving element is set back relative to a surface of the cover element that is to be wiped. In particular, the relieving element is at a greater distance from the wiper unit than is the cover element. The wiper unit can thereby advantageously be relieved.

For example, the cover element could have at least one rectangular transition to the relieving element. When the cover element has at least one tangential transition to the relieving element, wear in particular can be reduced and/or cleaning can be improved. In particular, the cover element has at least one radius to the relieving element. It would likewise be conceivable that the cover element has at least two radii of different sizes to the relieving element. It would likewise be conceivable that the cover element has at least one chamfer to the relieving element. The cover element could have at least one chamfer and at least one radius to the relieving element.

Particularly advantageous properties in terms of safety can be achieved by a vehicle having a lidar device.

The lidar device according to the invention is not to be limited to the above-described application and embodiment. In particular, the lidar device according to the invention can have a number of individual elements, components and units that differs from the number mentioned herein in order to fulfil a function described herein. In addition, in the case of the value ranges given in this disclosure, values lying within the mentioned limits are also to be regarded as disclosed and usable as desired.

### BRIEF DESCRIPTION OF THE DRAWINGS

Further advantages will become apparent from the following description of the drawing. In the drawing, twelve exemplary embodiments of the invention are shown. The drawing, the description and the claims contain numerous features in combination. The person skilled in the art will expediently also consider the features individually and combine them to form expedient further combinations.

In the drawing:

FIG. 1 shows a vehicle having a lidar device in a simplified perspective view,

FIG. 2 shows the lidar device having a lidar unit and having a cover element in a simplified perspective view,

FIG. 3 shows the lidar device having a cleaning unit in a simplified side view,

FIG. 4 shows part of the cleaning device having a wiper unit in a simplified cross-sectional view,

FIG. 5 shows the wiper unit having a wiper blade and having a pressing element which provides a pressing force for the wiper blade, and an exemplary pressing force curve,

FIG. 6 shows the cover element and a relieving element of the lidar device in a simplified cross-sectional view,

FIG. 7a-e show the relieving element with possible tangential transitions to the cover element,

FIG. 8 shows the relieving element in a simplified perspective view,

FIG. 9 shows part of a lidar device of a further exemplary embodiment of the invention having a cover element and having a relieving element in a simplified perspective view,

FIG. 10 shows part of a lidar device of a further exemplary embodiment of the invention having a cover element and having a relieving element in a simplified cross-sectional view,

FIG. 11-12 show part of a lidar device of a further exemplary embodiment of the invention having a cover element and having a relieving element in a simplified cross-sectional view,

FIG. 13-14 show part of a lidar device of a further exemplary embodiment of the invention having a slide unit in a simplified cross-sectional view,

FIG. 15-16 show part of a lidar device of a further exemplary embodiment of the invention having a pressing element in a simplified cross-sectional view,

FIG. 17-18 show part of a lidar device of a further exemplary embodiment of the invention having a pressing element in a simplified cross-sectional view,

FIG. 19-20 show part of a lidar device of a further exemplary embodiment of the invention having a pressing element in a simplified cross-sectional view,

FIG. 21-22 show part of a lidar device of a further exemplary embodiment of the invention having a pressing element in a simplified cross-sectional view,

FIG. 23 shows part of a lidar device of a further exemplary embodiment of the invention having a cleaning unit which has a pressing element which forms a fluid channel,

FIG. 24 shows part of a lidar device of a further exemplary embodiment of the invention having a pressing element in a simplified cross-sectional view, and

FIG. 25 shows part of a lidar device of a further exemplary embodiment of the invention having a pressing element in a simplified cross-sectional view.

### DETAILED DESCRIPTION

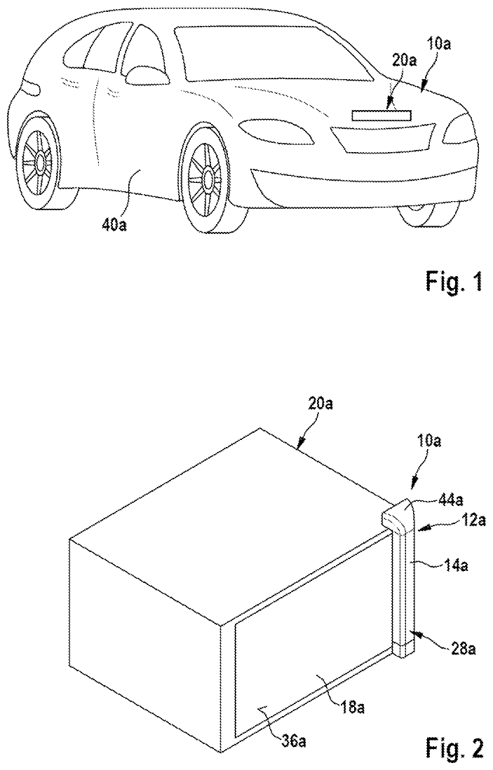

FIG. 1 shows a vehicle 40a. The vehicle 40a comprises a lidar device 10a. The vehicle 40a is in the form of a road vehicle, in particular in the form of a passenger car. The lidar device 10a is arranged in a front region of the vehicle 40a. The lidar device 10a is in particular connected to the vehicle 40a in the front region.

The lidar device 10a has a lidar unit 20a, which is shown in simplified form in FIG. 2. The lidar unit 20a comprises at least one lidar sensor (not shown). The lidar device 10a in the exemplary embodiment shown additionally comprises a cover element 18a.

The cover element 18a covers the lidar unit 20a. The cover element 18a is provided for protecting the lidar unit 20a from environmental influences and in particular from dirt and/or moisture. The lidar device 10a has a cleaning unit 12a. The cleaning unit 12a is configured to clean the cover element 18a.

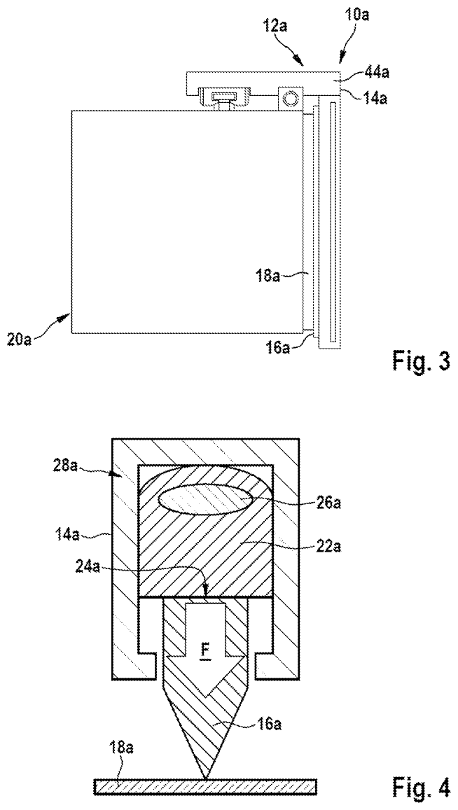

The cleaning unit 12a is provided for cleaning the cover element 18a at least mechanically. For mechanically cleaning the cover element 18a, the cleaning unit 12a has a wiper unit 14. The cleaning unit 12a additionally has a transport unit 44a (see also FIG. 3). The transport unit 44a moves the wiper unit 14a linearly over the cover element 18a for cleaning the cover element 18a. Specifically, the transport unit 44a moves the wiper unit 14a bidirectionally over the cover element 18a for cleaning the cover element 18a.

The wiper unit 14a has a wiper blade 16a for mechanically cleaning the cover element 18a. The transport unit 44a moves the wiper blade 16a bidirectionally over the cover element 18a for cleaning the cover element 18a.

The lidar device 10a has a pressing element 22a. In a mounted state, the pressing element 22a provides a pressing force for the wiper blade 16a. In the mounted state, the pressing element 22a presses the wiper blade 16a against the cover element 18a.

The pressing element 22a is in the form of an elastic element. In the present exemplary embodiment, the pressing element 22a is formed entirely of a flexurally elastic plastics material. The pressing element 22a has a substantially higher stiffness than the wiper blade 16a.

In the present exemplary embodiment, the pressing element 22a is part of the wiper unit 14a (see also FIG. 4). Specifically, the pressing element 22a is connected integrally to the wiper blade 16a. In the exemplary embodiment shown, the wiper blade 16a is connected to the pressing element 22a in a middle region 24a of the pressing element 22a.

The pressing element 22a has a cavity 26a. When seen in cross-section, the pressing element 22a encloses the cavity 26a completely. The cavity 26a forms a hollow channel through the pressing element 22a.

The wiper unit 14a has a housing unit 28a. The housing unit 28a supports the pressing element 22a in at least one direction. The pressing element 22a is connected by positive engagement to the housing unit 28a. The pressing element 22a has, at least in a part-region, an outer form which corresponds at least in a part-region to an inner form of the housing unit 28a.

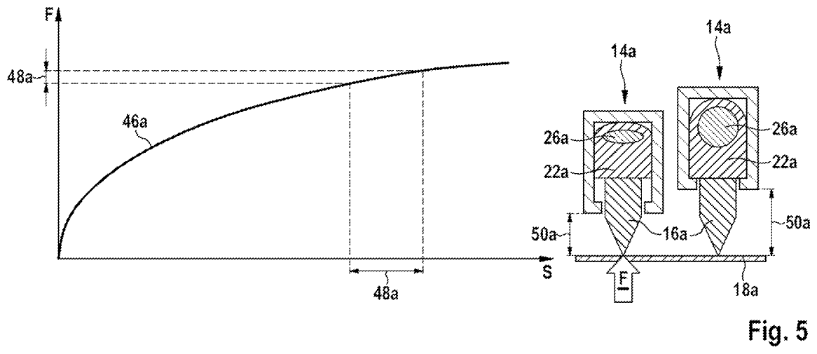

FIG. 5 shows, in simplified form, the pressing element 22a in a cross-sectional view in a preloaded state, which corresponds to the mounted state. FIG. 5 additionally shows by way of example the pressing element 22a in a cross-sectional view in a relieved state, which is present in particular when the wiper unit 14a is at a sufficient distance 50a from the cover element 18a but is shown in FIG. 5 only by way of example for explanatory purposes. FIG. 5 additionally shows by way of example a pressing force curve 46a, in particular a preload force curve, in dependence on a deflection of the elastic pressing element 22a, which corresponds substantially to the distance 50a.

The pressing element 22a is designed to provide a degressive pressing force curve 46a. The pressing element 22a is provided for providing a degressive pressing force curve 46a with respect to the distance 50a of the wiper unit 14a from the cover element 18a. Specifically, the distance 50a between the wiper unit 14a and the cover element 18a in the mounted state is so chosen that the pressing force, in particular a preload force, lies in an approximately linear part-region 48a of the degressive pressing force curve 46a.

The lidar device 10a additionally has a relieving element 32a. The relieving element 32a is arranged adjoining the cover element 18a. The relieving element 32a is provided for relieving the wiper unit 14a. Specifically, the relieving element 32a relieves the wiper blade 16a and the pressing element 22a of the wiper unit 14a in a parking position 34a, which additionally constitutes a change-of-direction position.

The relieving element 32a is at a greater distance 50a from the wiper unit 14a than is the cover element 18a, whereby the wiper unit 14a is relieved when it passes over the relieving element 32a.

The relieving element 32a provides a parking position 34a for the wiper unit 14a. The parking position 34a is additionally a change-of-direction position for the wiper unit 14a. The wiper unit 14a is provided for parking above the relieving element 32a, that is to say above the parking position 34a provided by the relieving element 32a, in a parked state.

In wiping operation, which in the present exemplary embodiment is bidirectional wiping operation, the wiper unit 14a is provided for travelling beyond the cover element 18a on both sides and for changing direction above each relieving element 32a.

The relieving element 32a is formed integrally with the cover element 18a. In the present exemplary embodiment, the cover element 18a is formed in one piece with the relieving element 32a. The relieving element 32a is set back relative to a surface 36a of the cover element 18a that is to be wiped.

In principle, in particular a rectangular transition of the cover element 18a to the relieving element 32a would be conceivable. Preferably, the cover element 18a has at least one tangential transition 38a to the relieving element 32a.

FIGS. 7a to 7e show a selection of conceivable tangential transitions 38a of the cover element 18a to the relieving element 32a. By way of example, the cover element 18a could have a chamfer as the transition 38a to the relieving element 32a (see FIG. 7a). By way of example, the cover element 18a could have a radius and an adjoining chamfer as the transition 38a to the relieving element 32a (see FIG. 7b). By way of example, the cover element 18a could have a chamfer and an adjoining radius as the transition 38a to the relieving element 32a (see FIG. 7c). By way of example, the cover element 18a could have a radius as the transition 38a to the relieving element 32a (see FIG. 7d). By way of example, the cover element 18a could have at least two different radii as the transition 38a to the relieving element 32a (see FIG. 7e).

The relieving element 32a is additionally provided for dissipating liquid. In the present exemplary embodiment, the relieving element 32a has a plurality of openings 52a. The openings 52a are provided for dissipating liquid. Specifically, the openings 52a are provided for dissipating washing water (not shown) and/or rainwater (not shown) and/or dirty water (not shown).

In wiping operation, the wiper unit 14a wipes the liquid for cleaning the cover element 18a in particular bidirectionally to the side of the relieving element 32a. For example, a headwind during a journey additionally ensures that the liquid flows to the side of the cover element 18a. The liquid is able to flow away via the openings 52a.

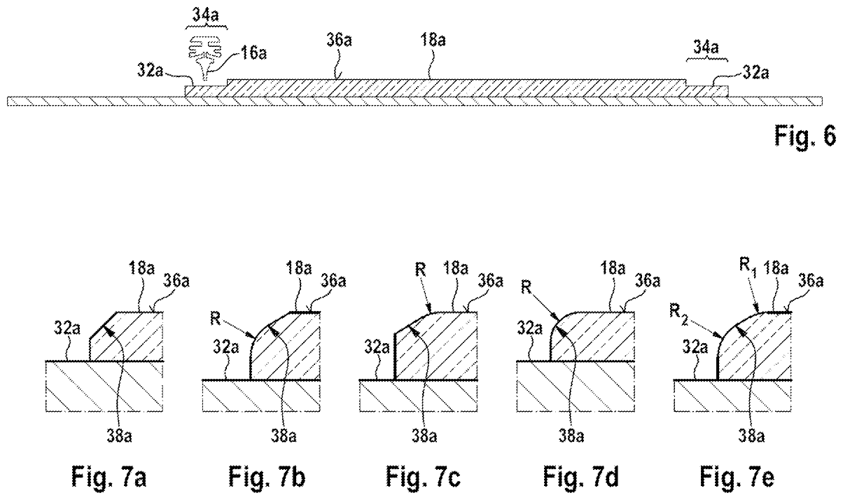

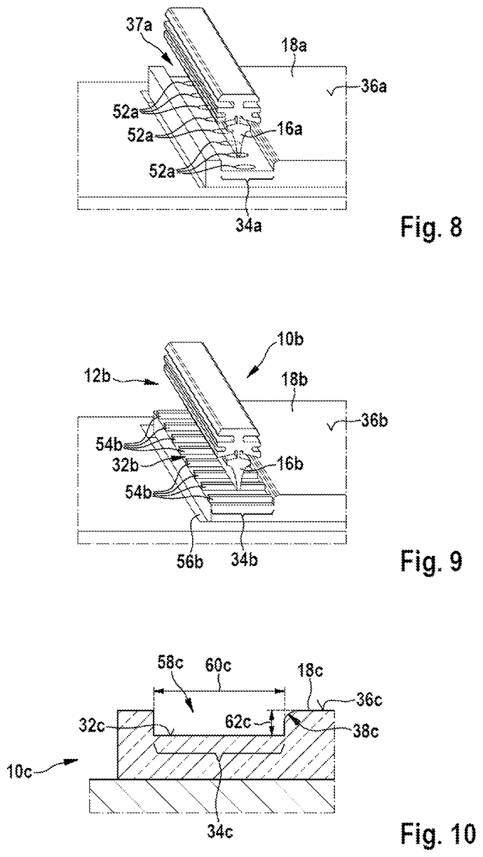

FIGS. 9 to 25 show eleven further exemplary embodiments of the invention. The following descriptions and the drawings are limited substantially to the differences between the exemplary embodiments, wherein reference may be made in respect of components that are referred to identically, in particular with regard to components having identical reference numerals, in principle also to the drawings and/or the description of the other exemplary embodiments, in particular of FIGS. 1 to 8. In order to distinguish between the exemplary embodiments, the reference numerals of the exemplary embodiment in FIGS. 1 to 8 are followed by the letter a. In the exemplary embodiments of FIGS. 9 to 25, the letter a is replaced by the letters b to l.

FIG. 9 shows part of a lidar device 10b of a further exemplary embodiment of the invention. The lidar device 10b comprises a cover element 18b. For cleaning the cover element 18b, the lidar device 10b comprises a cleaning unit 12b having a wiper unit 14b, which in the present FIG. 9 is shown in highly simplified form.

The lidar device 10b additionally has a relieving element 32b. The relieving element 32b is arranged adjoining the cover element 18b. The relieving element 32b is provided for relieving the wiper unit 14b.

The lidar device 10b of this exemplary embodiment differs from the lidar device of the preceding exemplary embodiment substantially in particular by a configuration of the relieving element 32b.

The relieving element 32b is provided for dissipating liquid. In the present exemplary embodiment, the relieving element 32b has a plurality of guide elements 54b. In the example shown, the guide elements 54b are in the form of guide ribs. The guide elements 54b in the form of guide ribs extend parallel to a wiping direction. It would be conceivable that the guide elements 54b are so arranged that they slope downwards to the outside.

During wiping operation, the wiper unit 14b wipes the liquid for cleaning the cover element 18b in particular bidirectionally to the side of the relieving element 32b. For example, headwind during a journey additionally ensures that the liquid flows to the side of the cover element 18b. The guide elements 54b conduct the liquid away to the side in the operating state. The guide elements 54b are provided for guiding the liquid. Specifically, the guide elements 54b are provided for conducting liquid away from the cover element 18b, in particular in the direction of a recess 56b of the lidar device 10b, during a journey and/or during washing operation.

In particular, the guide elements 54b of the relieving element 32b of the present exemplary embodiment can be combined with the openings 52a of the relieving element 32a of the preceding exemplary embodiment.

FIG. 10 shows part of a lidar device 10c of a further exemplary embodiment of the invention. The lidar device 10c comprises a cover element 18c.

The lidar device 10c additionally has a relieving element 32c. The relieving element 32c is arranged adjoining the cover element 18c. The relieving element 32c is provided for relieving a wiping unit of a cleaning unit (not shown) of the lidar device 10c.

The lidar device 10c of this exemplary embodiment differs from the lidar devices of the preceding exemplary embodiments substantially in particular by a configuration of the relieving element 32c.

The relieving element 32c is provided for dissipating liquid. The relieving element 32c of the present exemplary embodiment has a channel 58c. The relieving element 32c defines the channel 58c and delimits it on three sides. In the example shown, the channel 58c extends perpendicular to a wiping direction. The channel 58c is provided for conducting liquid away. Specifically, the channel 58c is provided for conducting liquid downwards, when viewed in the installation position.

FIG. 10 shows only a simplified cross-sectional view of the channel 58c. It would be conceivable that a channel 58c is arranged on each side of the cover element 18c. For example, the channel 58c could be arranged in particular so that it surrounds the cover element 18c completely.

The channel 58c has a ratio of a width 60c of the channel 58c to a depth 62c of the channel 58c which has a value of not more than 1.

In particular, the channel 58c of the relieving element 32c of the present exemplary embodiment can be combined at least with the openings 52a of the relieving element 32a of the first exemplary embodiment and/or with the guide elements 54c of the relieving element 32b of the preceding exemplary embodiment.

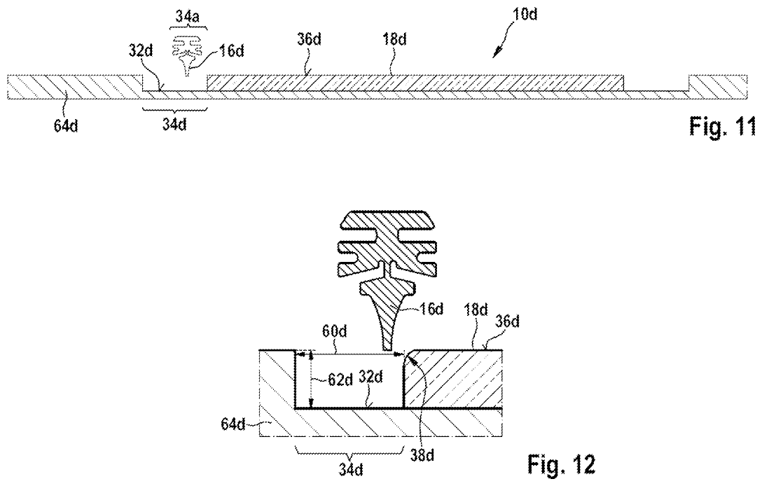

FIGS. 11 and 12 show part of a lidar device 10d of a further exemplary embodiment of the invention, in each case in a simplified cross-sectional view. The lidar device 10d comprises a cover element 18d.

The lidar device 10d additionally has a relieving element 32d. The relieving element 32d is arranged adjoining the cover element 18d. The relieving element 32d is provided for relieving a wiper unit of a cleaning unit (not shown) of the lidar device 10d.

The lidar device 10d of this exemplary embodiment differs from the lidar devices of the preceding exemplary embodiments substantially in particular by a configuration of the relieving element 32d.

The relieving element 32d of the present exemplary embodiment of the invention is part of a frame 64d of the lidar device 10d. The frame 64d is arranged around the cover element 18d, in particular behind the cover element 18d.

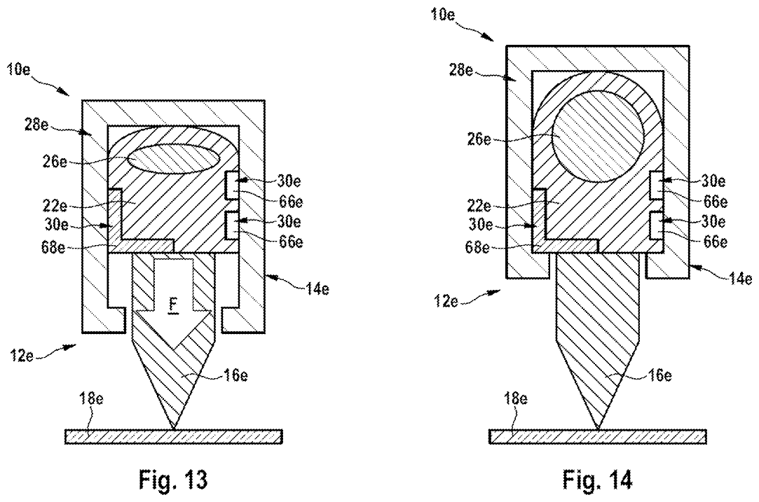

FIGS. 13 and 14 show part of a lidar device 10e of a further exemplary embodiment of the invention in simplified form in a cross-sectional view.

The lidar device 10e has a cover element 18e and a cleaning unit 12e. The cleaning unit 12e is configured to clean the cover element 18e. For mechanically cleaning the cover element 18e, the cleaning unit 12e has a wiper unit 14e. The wiper unit 14e has a wiper blade 16e for mechanically cleaning the cover element 18e.

The wiper unit 14e has a pressing element 22e. The pressing element 22e provides a pressing force for the wiper blade 16e in a mounted state. The pressing element 22e presses the wiper blade against the cover element 18e in the mounted state.

In the mounted state, the pressing element 22e is so mounted inside a housing unit 28e of the wiper unit 14e that the pressing element 22e is able to deform elastically in order to provide the pressing force. In particular, the pressing element 22e is displaceable at least in a part-region relative to the housing unit 28e.

The lidar device 10e has a slide unit 30e. The slide unit 30e is provided for reducing friction between the housing unit 28e and the pressing element 22e in the mounted state.

The slide unit 30e comprises at least one recess 66e, arranged at the pressing element 22e, for reducing a contact surface between the pressing element 22e and the housing unit 28a. By way of example, the slide unit 30e comprises two recesses 66e arranged at the pressing element 22e for reducing a contact surface between the pressing element 22e and the housing unit 28e.

The slide unit 30e additionally comprises, in at least a part-region of the pressing element 22e and of the housing unit 28e, a material pairing which has low friction. In particular, the housing unit 28e is produced from a plastics material, for example. The slide unit 30e has a slide region 68e, which in the present example is arranged on the pressing element 22e. In the present example, the slide region 68e of the pressing element 22e has material which together with the housing unit 28e has low friction, for example PTFE.

It would be conceivable that the slide unit 30e comprises only the at least one recess 66e or the material pairing, in particular the slide region 68e. The slide unit 30e can of course be combined with the configurations of the other exemplary embodiments.

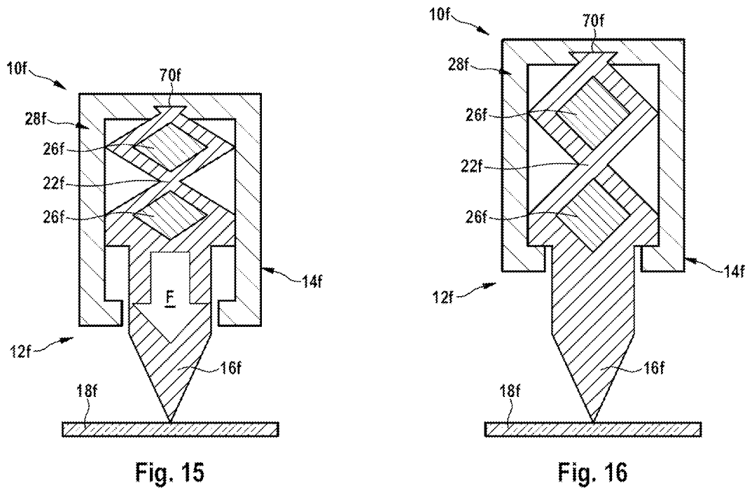

FIGS. 15 and 16 show part of a lidar device 10f of a further exemplary embodiment of the invention in simplified form in a cross-sectional view.

The lidar device 10f has a cover element 18f and a cleaning unit 12f The cleaning unit 12f is configured to clean the cover element 18f. For cleaning the cover element 18f, the cleaning unit 12f has a wiper unit 14f. The wiper unit 14f has a wiper blade 16f for cleaning the cover element 18f.

The wiper unit 14f has a pressing element 22f. In a mounted state, the pressing element 22f provides a pressing force for the wiper blade 16f. In the mounted state, the pressing element 22f presses the wiper blade against the cover element 18f.

FIG. 15 shows the pressing element 22f by way of example in a preloaded mounted state, in which the pressing element 22f provides the pressing force. FIG. 16 shows the pressing element 22f by way of example in an unloaded state, for example in a premounted state.

The pressing element 22f differs from the pressing elements of the preceding exemplary embodiments at least in respect of a shaping. The pressing element 22f has a shaping with a plurality of at least substantially triangular part-regions. The pressing element 22f in the present exemplary embodiment delimits by way of example two cavities 26f.

The pressing element 22f is connected by positive engagement to a housing unit 28f of the wiper unit 14f Specifically, the pressing element 22f in the mounted state, when seen in cross-section, is held by positive engagement in a holding groove 70f of the housing unit 28f.

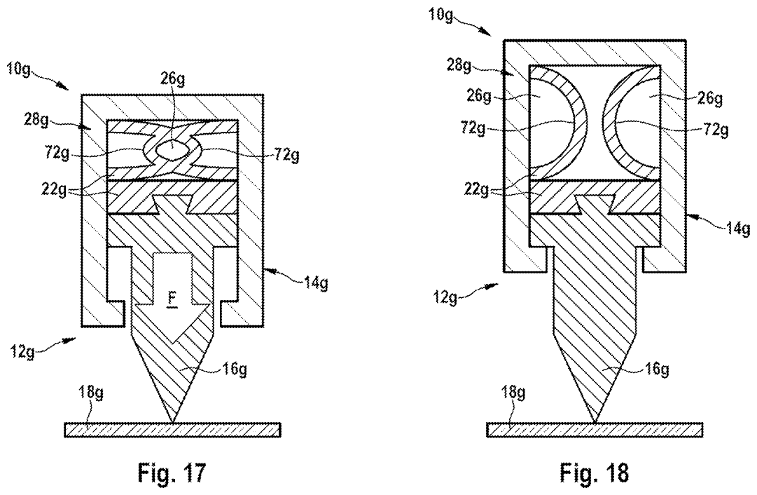

FIGS. 17 and 18 show part of a lidar device 10g of a further exemplary embodiment of the invention in simplified form in a cross-sectional view.

The lidar device 10g has a cover element 18g and a cleaning unit 12g. The cleaning unit 12g is configured to clean the cover element 18g. For cleaning the cover element 18g, the cleaning unit 12g has a wiper unit 14g. The wiper unit 14g has a wiper blade 16g for cleaning the cover element 18g.

The wiper unit 14g has a pressing element 22g. The pressing element 22g of the lidar device 10g of the present exemplary embodiment is separate from a wiper blade 16g of the wiper unit 14g. In the mounted state, the wiper blade 16g in the example shown is connected by positive engagement to the pressing element 22g.

FIG. 17 shows the pressing element 22g by way of example in a preloaded, mounted state, in which the pressing element 22g provides the pressing force. FIG. 18 shows the pressing element 22g by way of example in an unloaded state, for example in a premounted state.

The pressing element 22g additionally differs from the pressing elements of the preceding exemplary embodiments at least in respect of a shaping. The pressing element 22g has a shaping with a plurality of at least substantially semi-circular part-regions 72g. In the preloaded, mounted state, the semi-circular part-regions 72g are elastically deflected in order to provide a pressing force for the wiper blade 16g. The semi-circular part-regions 72g overlap in the preloaded, mounted state.

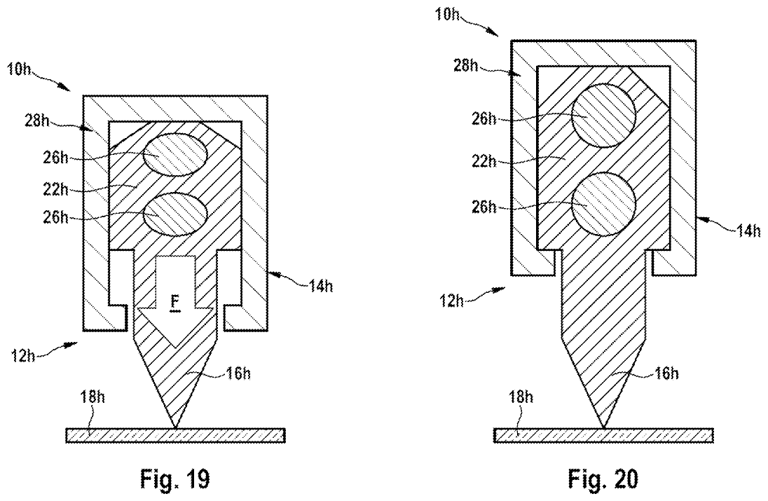

FIGS. 19 and 20 show part of a lidar device 10h of a further exemplary embodiment of the invention in simplified form in a cross-sectional view.

The lidar device 10h has a cover element 18h and a cleaning unit 12h. The cleaning unit 12h is configured to clean the cover element 18h. For cleaning the cover element 18h, the cleaning unit 12h has a wiper unit 14h. The wiper unit 14h has a wiper blade 16h for cleaning the cover element 18h.

The wiper unit 14h has a pressing element 22h. In a mounted state, the pressing element 22h provides a pressing force for the wiper blade 16h. FIG. 19 shows the pressing element 22h by way of example in a preloaded mounted state, in which the pressing element 22h provides the pressing force. FIG. 20 shows the pressing element 22h by way of example in an unloaded state, for example in a premounted state.

At least in the unloaded state shown, the pressing element 22h is connected by positive engagement to a housing unit 28h of the wiper unit 14h. The pressing element 22h of the present exemplary embodiment is formed in one piece with the wiper blade 16h.

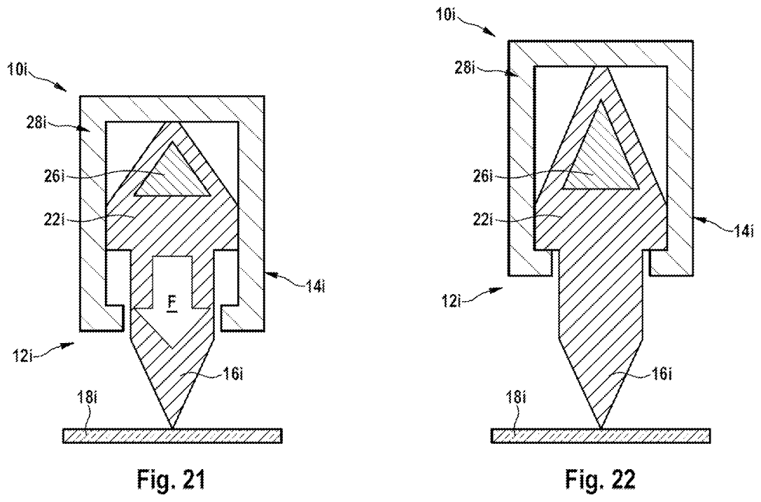

FIGS. 21 and 22 show part of a lidar device 10i of a further exemplary embodiment of the invention in simplified form in a cross-sectional view.

The lidar device 10i has a cover element 18i and a cleaning unit 12i. The cleaning unit 12i is configured to clean the cover element 18i. For cleaning the cover element 18i, the cleaning unit 12i has a wiper unit 14i. The wiper unit 14i has a wiper blade 16i for cleaning the cover element 18i.

The wiper unit 14i has a pressing element 22i. In a mounted state, the pressing element 22i provides a pressing force for the wiper blade 16i. FIGS. 21 and 22 show by way of example a further possible shaping of the pressing element 22i, specifically in a preloaded mounted state and by way of example in an unloaded state. In addition, a further possible shaping of a cavity 26i enclosed by the pressing element 22i is shown by way of example.

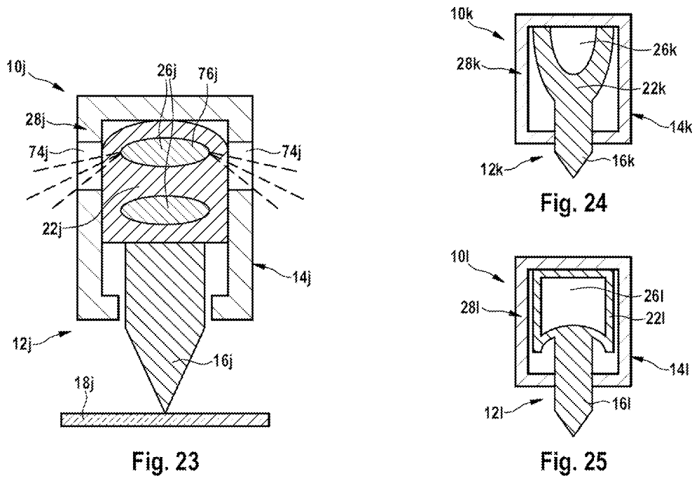

FIG. 23 shows part of a lidar device 10j of a further exemplary embodiment of the invention in simplified form in a cross-sectional view.

The lidar device 10j has a cover element 18j and a cleaning unit 12j. The cleaning unit 12j is configured to clean the cover element 18j. For cleaning the cover element 18j, the cleaning unit 12j has a wiper unit 14j. The wiper unit 14j has a wiper blade 16j for cleaning the cover element 18j.

The cleaning unit 18j is additionally provided for cleaning the cover element 18j by means of a cleaning fluid. For applying the cleaning fluid to the cover element 18j, the cleaning unit 18j has fluid nozzles 74j. In the example shown, the fluid nozzles 74j are part of the wiper unit 14j.

For supplying the fluid nozzles 74j with cleaning fluid, the wiper unit 14j has a fluid channel 76j. It would be conceivable that the wiper unit 14j has a plurality of fluid channels 76j. The fluid channel 76j is part of the pressing element 22j. Specifically, a cavity 26j defined by the pressing element 22j, that is to say enclosed by the pressing element 22j, forms the fluid channel 76j.

The configuration of the invention shown in FIG. 23 can of course be combined with the configurations of the other exemplary embodiments.

FIG. 24 shows part of a lidar device 10k of a further exemplary embodiment of the invention in simplified form in a cross-sectional view. The lidar device 10k has a wiper unit 14k of a cleaning unit 12k having a pressing element 22k for providing a pressing force for a wiper blade 16k of the wiper unit 14k.

FIG. 24 shows by way of example a further possible shaping of the pressing element 22k. In addition, a further possible shaping of a cavity 26k enclosed by the pressing element 22k and a housing unit 28k of the wiper unit 14k is shown by way of example.

FIG. 25 shows part of a lidar device 10l of a further exemplary embodiment of the invention in simplified form in a cross-sectional view. The lidar device 10l has a wiper unit 14l of a cleaning unit 121 having a pressing element 22l for providing a pressing force for a wiper blade 16l of the wiper unit 14l.

FIG. 25 shows by way of example a further possible shaping of the pressing element 22l. In addition, a further possible shaping of a cavity 26l enclosed by the pressing element 22l and a housing unit 281 of the wiper unit 14l is shown by way of example.

1. A lidar device (10a-10l) having a cleaning unit (12a-12l) which has at least one wiper unit (14a-14l) having at least one wiper blade (16a-16l) for mechanically cleaning a cover element (18a-18l) of a lidar unit (20a-20l), and having at least one pressing element (22a-22l) which in a mounted state provides a pressing force for the wiper blade (16a-16l).

2. The lidar device (10a-10l) according to claim 1, characterized in that the wiper unit (14a-14l) has the pressing element (22a-22l).

3. The lidar device (10a-10l) according to claim 1, characterized in that the pressing element (22a-22l) is in the form of an elastic element.

4. The lidar device (10a-10l) according to claim 3, characterized in that the pressing element (22a-22l) is formed at least in part of a flexurally elastic plastics material.

5. The lidar device (10a-10l) according to claim 1, characterized in that the pressing element (22a-22l) has a substantially higher stiffness than the wiper blade (16a-16l).

6. The lidar device (10a) according to claim 5, characterized in that the pressing element (22a) is provided for providing a degressive pressing force curve (46a) in respect of a distance (50a) of the wiper unit (14a) from the cover element (18a), wherein the distance (50a) between the wiper unit (14a) and the cover element (18a) is so chosen that the pressing force, lies in an approximately linear part-region (48a) of the degressive pressing force curve (46a).

7. The lidar device (10a-10l) according to claim 1, characterized in that the pressing element (22a-22l) is connected integrally to the wiper blade (16a-16l).

8. The lidar device (10a-10l) according to claim 1, characterized in that the wiper blade (16a-16l) is connected to the pressing element (22a-22l) in a middle region (24a-241) of the pressing element.

9. The lidar device (10a-10l) according to claim 1, characterized in that the pressing element (22a-22l) delimits at least in part at least one cavity (26a-26l).

10. The lidar device (10a-10l) according to claim 1, characterized in that the wiper unit (14a-14l) has a housing unit (28a-28l) which supports the pressing element (22a-22l) at least in one direction.

11. The lidar device (10a-10j) according to claim 10, characterized in that the pressing element (22a-22j) is connected by positive engagement to the housing element (28a-28j).

12. The lidar device (10e) according to claim 10, characterized by a slide unit (30e) which is provided for reducing friction between the housing unit (28e) and the pressing element (22e).

13. The lidar device (10e) according to claim 12, characterized in that the slide unit (30e) comprises at least one recess (66e) arranged at the pressing element (22e) for reducing a contact surface between the pressing element (22e) and the housing unit (28e).

14. The lidar device (10e) according to claim 12, characterized in that the slide unit (30e) has in at least a part-region of the pressing element (22e) and of the housing unit (28e) at least one material pairing which has low friction.

15. The lidar device (10a-10d) according to claim 1, characterized by the cover element (18a-18d) and at least one relieving element (32a-32d), adjoining the cover element (18a-18d) and in particular arranged spaced apart from the cover element (18a-18d), for relieving the wiper unit (14a-14d), in a parking position (34a-34d) of the wiper unit (14a-14d).

16. The lidar device (10a-10d) according to claim 9, characterized in that the relieving element (32a-32d) is additionally provided for dissipating liquid.

17. The lidar device (10a-10c) according to claim 9, characterized in that the relieving element (32a-32c) is formed integrally with the cover element (18a-18c).

18. The lidar device (10a-10d) according to claim 9, characterized in that the relieving element (32a-32d) is set back relative to a surface (36a-36d) of the cover element (18a-18d) that is to be wiped.

19. The lidar device (10a) according to claim 9, characterized in that the cover element (18a) has at least one tangential transition (38a) to the relieving element (32a).

20. A vehicle (40a-40i) having a lidar device (10a-10i) according to claim 1.
